(19) United States
(12) Patent Application Publication
(10) Pub. No.: US 2019/0329619 A1
(43) Pub. Date: Oct. 31, 2019

(54) BEARING DEVICE FOR A LEAF SPRING ASSEMBLY OF A WHEEL SUSPENSION

(71) Applicant: ZF Friedrichshafen AG, Friedrichshafen (DE)

(72) Inventors: Thomas RUPFLIN, Stetten (DE); Peter HOFMANN, Starnberg (DE)

(21) Appl. No.: 16/074,156

(22) PCT Filed: Jan. 9, 2017
(86) PCT No.: PCT/EP2017/050294

§ 371 Date: Jul. 31, 2018

(30) Foreign Application Priority Data
Feb. 10, 2016 (DE) 10 2016 201 965.1

(51) Int. Cl. B60G 11/12; B60G 11/08

(52) U.S. Cl. CPC B60G 11/12; B60G 2206/7101; B60G 11/08

(57) ABSTRACT

A bearing device (7) for a leaf spring assembly (1) of a wheel suspension, having a leaf spring (2) and a connection device, which serves for the installation of the leaf spring (2) at the vehicle body. The connection device has a bolt. The leaf spring (2) is fabricated from a fiber composite material and has a recess that passes through the leaf spring, in a transverse direction, and through which the bolt (10) extends in order to provide the bearing device (7) with a compact construction and a low manufacturing cost and effort.

This application is a National Stage completion of PCT/EP2017/050294 filed Jan. 9, 2017, which claims priority from German patent application serial no. 10 2016 201 965.1 filed Feb. 10, 2016.

### FIELD OF THE INVENTION

The invention concerns a bearing device for a leaf spring assembly of a wheel suspension, comprising a leave spring and a connecting assembly which is used for connecting a leaf spring to a vehicle body, whereby the connecting assembly has a bolt. In addition, the invention concerns the aforementioned bearing device comprising the leaf spring assembly.

### BACKGROUND OF THE INVENTION

The chassis of vehicles can have as a suspension spring, at least a leaf spring which extends in the transverse direction of the vehicle and which supports the structure of the vehicle with respect to the wheels which are retained on the wheel carriers. Respective transverse leaf springs can be used in wheel steering units which are designed as independent wheel suspensions, as solid axle, or as torsion beam axles which are a special form of the rigid axle. Torsion beam axles are mainly used the rear axle in small and medium sized vehicles with front wheel drive and are a cost-effective and space saving design which can easily be installed on the vehicle.

In addition, transverse leaf springs can in principal also be provided for chassis with independent wheel suspension, whereby in this case the respective wheel carrier, for instance, is linked through a multi-linkage and if necessary, through a sub-frame at the chassis structure, and is supported by the transverse leaf spring.

Transverse leaf springs which are used as suspension springs in wheel suspensions can be formed by a single, leaf shaped spring element or by several, positioned in a spring packet, leaf shaped spring elements. The advantages of the use of a transverse leaf spring, compared to the use of coil springs are the lower cost, lower space requirement, an inherent damping behavior of the leave spring, and perhaps a stabilization effect of the transverse leaf spring.

At both of its ends, the transverse leaf spring has either a mounting fixture by which they are guided at the wheel carrier, or the ends of the leaf spring support themselves at the mounting fixtures, which are provided directly at the wheel carrier. In addition, the transverse leaf spring is usually connected, in an area between the two ends, which is in each case spaced therefrom, directly or via a sub-frame on bearing devices.

Known from DE 10 2013 218 055 A1 is a bearing device for a leaf spring assembly in which a leaf spring is linked to a vehicle body through a connecting assembly. Hereby, the leaf spring is positioned in the area of a vehicle axle as a transverse leaf spring and is linked through a bolt of the connecting assembly to the vehicle body, whereby the bolt in this case passes through a holding fixture.

### SUMMARY OF THE INVENTION

Based on the above mentioned state of the technology, it is the object of the present invention to provide a bearing device which is characterized by a compact construction and low manufacturing effort.

This objective is achieved, based on the independent claims, in accordance with the stated characteristics. The following, dependent claims are presenting each advantageous embodiments of the invention. A leaf spring device with a bearing device is also the matter the invention.

In accordance with the invention, a bearing device comprises a leaf spring and a connection assembly which serves for connecting a leaf spring to a vehicle body. Hereby, the connecting assembly has a bolt through which the connection at the vehicle body is accomplished. In accordance with the invention, the leaf spring can hereby be designed as an independent leaf-shaped spring element or as several spring elements which are then compiled to a spring packet.

The bearing device is hereby preferably a part of a leaf spring assembly for a wheel suspension of a motor vehicle, whereby the leaf spring is herein designed in particular as a transverse leaf spring, meaning it is installed in the transverse direction of the motor vehicle.

Hereby, the leaf spring assumes the wheel steering tasks, in addition a stabilization effect and dependent on the structure of the leaf spring, also an internal damping behavior might he accomplished. On the body side, the leaf spring is then at least connected with one, but preferably with two bearing assemblies through which the forces introduced into the leaf spring are supported on the vehicle body.

The invention now includes the technical teaching that the leaf spring is made from a fiber composite material and is penetrated transversely with a recess through which the bolt is passed. In other words, the leaf spring thus consists of a fiber composite material and has a recess which extends transversely through the leaf spring, i.e., penetrates the leaf spring in a transverse direction. Through this recess, the bolt of the connecting device is passed.

Such an embodiment of a bearing device for a leaf spring assembly has the advantage that the bearing device can be realized, due to the passage of the bolt through the leaf spring with a low number of parts. Thus, the bearing device is characterized by a low manufacturing effort, and also a compact construction, as well as a low weight. At the same time, lateral and vertical forces can be reliably absorbed. Finally, a large number of common parts can be used.

In contrast, the bolt of the bearing device of DE 10 2013 218 055 A1 is passed through a connection device, which is put on the leaf spring. This increases the assembly space and also accordingly the manufacturing effort. Also, a weight increase is taking place.

In accordance with the invention, the recess of the leaf spring extends in a transverse direction of the leaf spring, which means, for a transverse leaf spring in the installed position, the recess is oriented in the longitudinal direction of the vehicle. The transverse direction means an orientation in the direction of a transverse axis that is orthogonal to a longitudinal axis and a vertical axis of the leaf spring.

The recess may be implemented in the leaf spring, meaning through appropriate removal of material, or the recess is already defined during the manufacturing process of the leaf spring. In particular, the recess has a circular cross section, but other different designs are also possible. In addition, the recess runs preferably through a neutral fiber of the leaf spring.

The used fiber composite material of the leaf spring is preferably GFK (fiber glass reinforced synthetic), because a suitable characteristic for the leaf spring can be realized, and at the same time has a low weight. Alternatively, a different fiber synthetic composite can be used, or other fiber composite material.

In accordance with an embodiment of the invention, the bolt takes on both sides of the leaf spring, clamping devices which are pre-loaded towards each other on the bolt and thus against the intermediate leaf spring. Hereby, a reliable bearing of the leaf spring can be realized, because the clamping devices clamp the leaf spring and thus omit unwanted relative movements.

In a further design of the above mentioned embodiment, the clamping devices each comprise a clamping sleeve, wherein the clamping sleeves are further preferably each provided, on the side of the leaf spring, with a conical and/or cylindrical enlargement, through which the respective clamp sleeve is pre-loaded against the leave spring. Thus, clamping of the leaf spring therebetween can be realized in an advantageous manner. Due to the conical and/or cylindrical enlargements, the contact surface can hereby be enlarged, so that a sufficient support of the forces takes place.

In accordance with an additional embodiment of the previously mentioned configuration, a respective contact element is provided between the leaf spring and the respective clamping sleeve of the respective clamping device, which is tightened through the respective clamping sleeve against the leaf spring. Furthermore, the respective contact element has clamp-shape projections, through which it encompasses the leaf spring with the sides of the respective clamping device. The grip around the leaf spring via the pre-loaded contact elements against the leaf spring is further improved in this area by the fixation of the leaf spring, since unwanted relative movements of the leaf spring are positively-locked to the connecting device.

A fixation, in the sense of the invention, could also be positive-locking achieved through the sleeves whereby they, for a sufficient force support, in this case need to be provided with a respective large diameter or the conical and/or cylindrical enlargements. In addition, contact surfaces of the connecting device with the leaf spring can be generally provided with surfaces of a larger roughness, as for instance knurling.

It is an additional embodiment of the invention where the connecting device comprises rubber bearings via which the installation on the vehicle body is accomplished. In a further enhancement of this embodiment, the rubber bearings are each positioned on a respective clamping sleeve. In an advantageous manner, the transfer of sound and oscillation towards the vehicle body is hereby dampened.

In accordance with an embodiment of the invention the pre-load of the clamping devices is realized through a screw fastening. In this case, the pre-load of the damping devices can be realized in a simple manner. Preferably, the bolt has for this purpose a thread at least on one end. Specifically, the bolt can be hereby designed as a screw, whereby a nut is put on the threaded end, wherein a screw head and the nut provide pre-loading against each other for the intermediate components of the damping devices. The bolt can also be designed as a threaded bolt, which has the threads at both ends which accommodate the respective nuts, and which again preload the clamping devices against each other.

The invention is not limited to the named combination and characteristics of the principle claim or dependent claims. In addition, it is possibilities to combine individual characteristics with each other, as far as they are part of the following specification of preferred embodiments of the invention, or they are seen as a part of the drawings. The reference of the claims to the drawings by use of reference numerals is not intended to limit the scope of the claims.

### BRIEF DESCRIPTION OF THE DRAWINGS

Advantageous embodiments of the invention which are hereinafter described are presented in the drawings. These show:

FIG. 1 a schematic presentation of a leaf spring assembly;

FIG. 2 a perspective view of a bearing device of the leaf spring assembly of FIG. 1, according to a first embodiment of the invention;

FIG. 3 a sectional view of the bearing device as in FIG. 2;

FIG. 4 a perspective view of a bearing device of the leaf spring assembly as in FIG. 1, in accordance with the second embodiment of the invention;

FIG. 5 a section view of the bearing device as in FIG. 4; and

FIG. 6 a section view of a bearing device of the leaf spring assembly as in FIG. 1, in accordance with the third embodiment of the invention

### DETAILED DESCRIPTION OF THE PREFERRED EMBODIMENTS

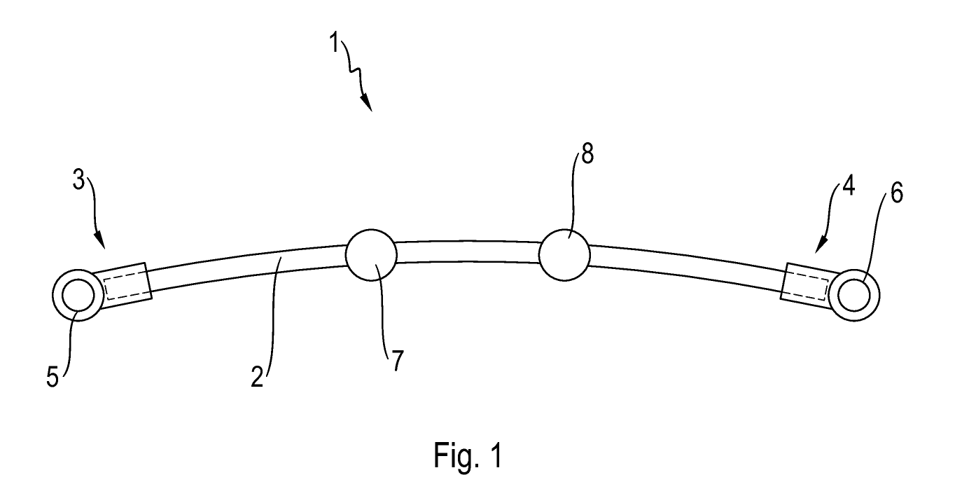

FIG. 1 presents a schematic view of a leaf spring assembly 1, which is used in a wheel suspension of a motor vehicle. The leaf spring assembly 1 comprises a leaf spring 2 made of a fiber composite material, which is preferably GFK (glass fiber reinforced plastic). Hereby, the leaf spring can be designed as one-layer, or composed of several single layers which are combined to form a packet.

The leaf spring 2 is connected, in the installed condition of the leaf spring assembly 1, at its ends 3 and 4 via the supports 5 and 6 with wheel carriers of the respective vehicle axle. In this respect, the leaf spring 2 is hereby installed as a transverse leaf spring, which runs transverse to the direction of travel of the motor vehicle. Between the two ends 5 and 6, the leaf spring 2 is also connected, in the installed condition of the leaf spring assembly 1, via bearing devices 7 and 8 to the vehicle body.

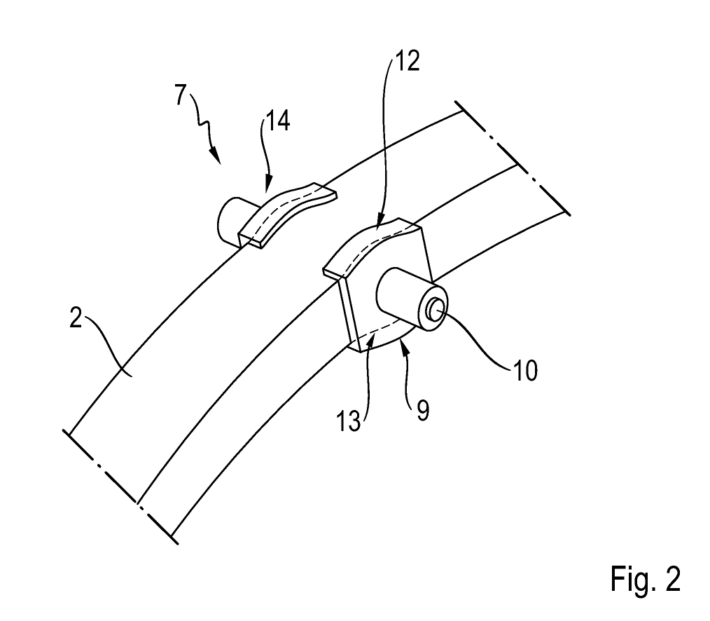

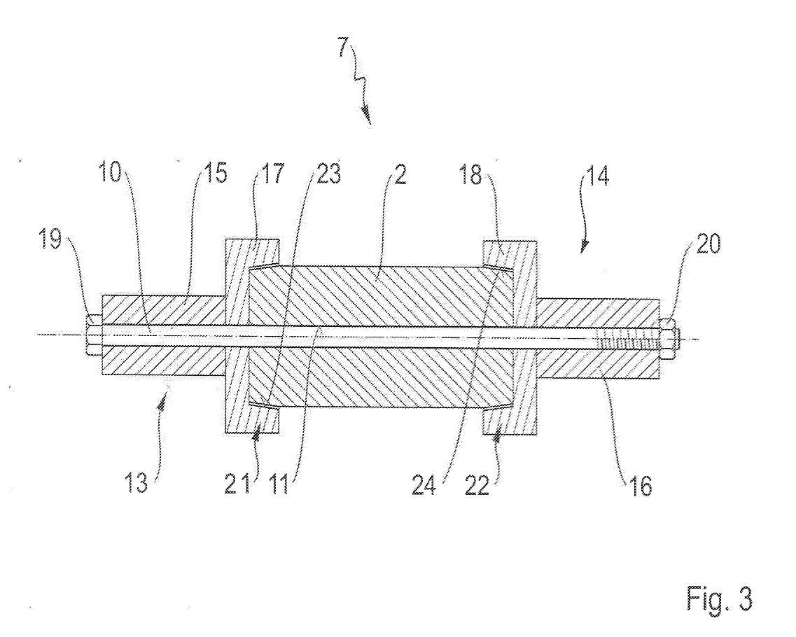

FIGS. 2 and 3 show a first embodiment in accordance with the invention of the bearing devices 7 and 8 using the example of the bearing device 7, wherein the bearing device 8 corresponds to the described embodiment. As one can see, the bearing device 7 comprises a connecting device 9 with a bolt 10 which is passed through—seen in FIG. 3—a recess 11 of the leaf spring 2. The recess 11 passes through the leaf spring 2 transversely in the region of a thickening 12, as shown in FIG. 2, and in the region of a neutral fiber of the leaf spring 2.

The bolt 10 is, in the present case, designed as a screw and carries on both sides, facing towards the leaf spring 2, the clamping devices 13 and 14, which are each assembled with a clamping sleeve 15 or 16, respectively, and a contact element 17 or 18, respectively, The clamping devices 13 and 14 are biased towards each other and thus against the leaf spring 2 positioned therebetween via a screw head 19 of the bolt 10, designed as a screw, and a nut 20 on the threaded end of the bolt 10.

As it can be seen in FIG. 3, the contact elements 17 and 18 each have a respective clamp-like projection 21 or 22, with which the respective contact element 17 or 18 engages around the spring leaf 2 from the respective side. The projections 21 and 22 each have chamfers 23 and 24, respectively, which firmly clamp in the course of pre-loading process the clamping devices 13 and 14 against the leaf spring 2 and its material. The contact surfaces of the projections 21 and 22 with the leaf spring 2 can hereby also designed with a larger surface roughness, for instance through respective knurling of the surfaces.

Placed on the clamping sleeves 15 and 16 are in addition rubber bearings—not shown here—which, in the installed condition of the leaf spring assembly 1 in FIG. 1, form a connection to the vehicle body.

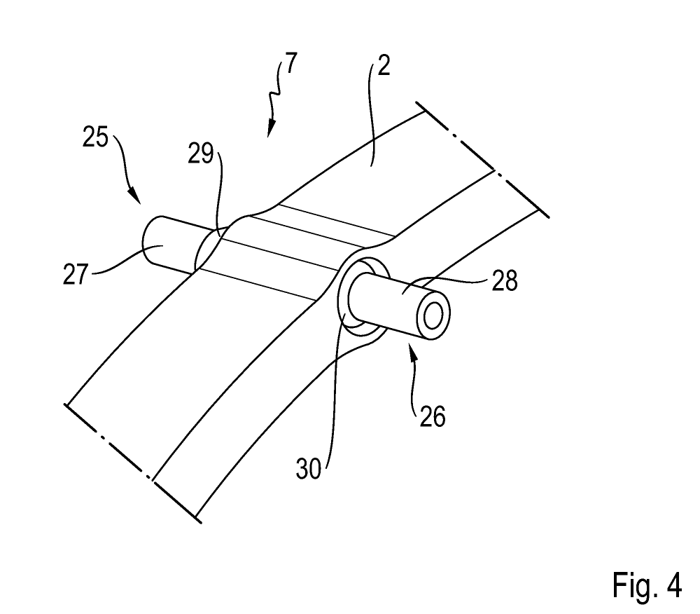

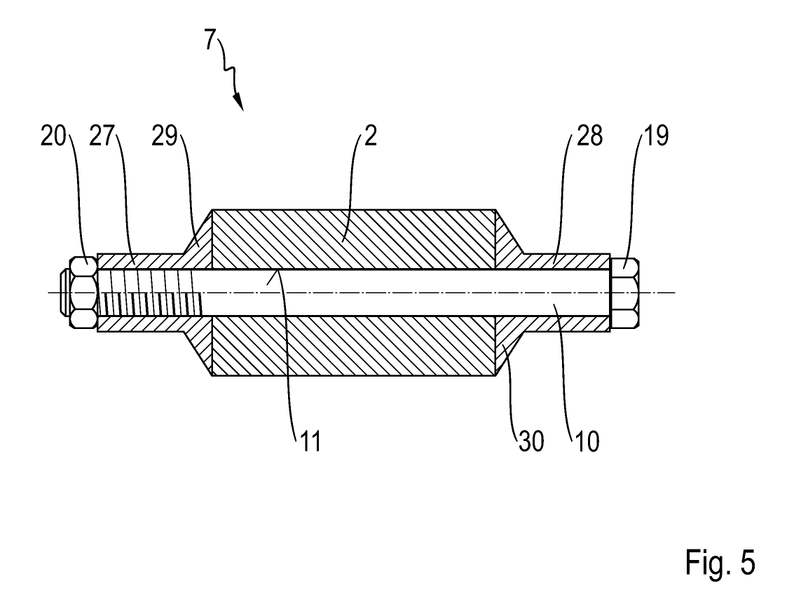

FIGS. 4 and 5 show an alternative embodiment of the bearing assemblies 7 and 8 according to a second design possibility of the invention. Again, this embodiment is described based on the bearing device 7, whereby the bearing device 8 is a similar design.

The embodiment according to FIGS. 4 and 5 essentially corresponds with the variation according to FIGS. 2 and 3, in contrast to which clamping devices 25 and 26 have no contact elements, but clamping sleeves 27 and 28 are directly pre-loaded against the leaf spring 2 positioned therebetween. Hereby, the clamping sleeves 27 and 28 on both sides of the leave spring 2 each have a conical and/or cylindrical enlargement 29 or 30, respectively, which are pre-loaded against the leave spring 2. As an alternative, a special contour can be used to minimize the surface pressure on the spring, for instance according to the tensile triangles method. Besides this, the embodiment according to FIGS. 4 and 5 corresponds to the variation as in FIGS. 2 and 3, so that the here described is referencing it.

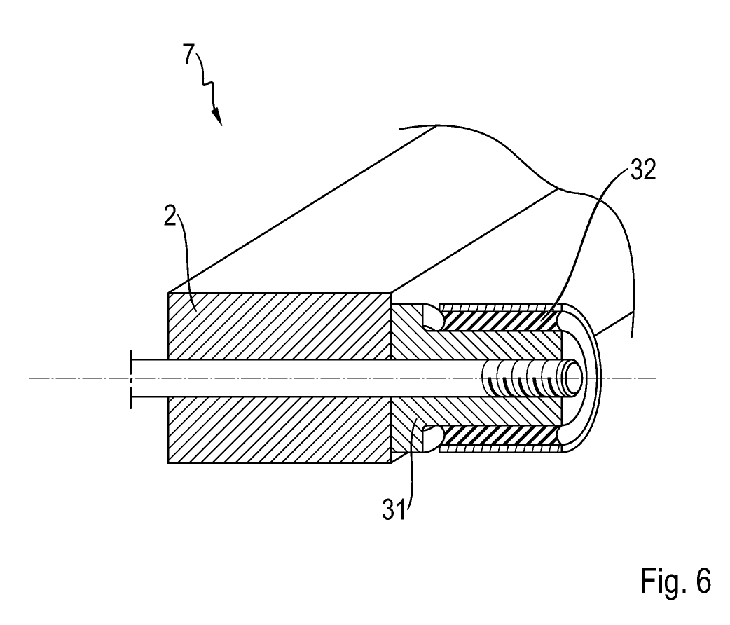

Finally, FIG. 6 shows an additional embodiment of the bearing devices 7 and 8 in accordance with a third variation of the invention, which is for instance described based on the bearing device 7. The bearing device 8 is similarly constructed.

The variation shown in FIG. 6 corresponds essentially with the previously described embodiment of FIGS. 4 and 5. Deviating are damping sleeves, of which in the present case only the damping sleeve 31 can be seen enlarged in the contact area with the leaf spring 2. In the case of the variation shown in FIG. 6, the rubber bearing 32 can additionally be seen. For that matter, the embodiment according to FIG. 6 corresponds to the variation according to FIGS. 4 and 5, so that the here described is referenced to it.

By means of the inventive embodiments, a bearing device can be created which is characterized by a compact construction and a low manufacturing effort.

### REFERENCE CHARACTERS

1 Leaf Spring Assembly

2 Leaf Spring

3 End Piece

4 End Piece

5 Support

6 Support

7 Bearing Device

8 Bearing Device

9 Connecting Assembly

10 Bolt

11 Recess

12 Thickening

13 Clamping Device

14 Clamping Device

15 Clamping Sleeve

16 Clamping Sleeve

17 Contact element

18 Contact element

19 Screw Head

20 Nut

21 Projection

22 Projection

23 Chamfers

24 Chamfers

25 Clamping Device

26 Clamping Device

27 Clamping Sleeve

28 Clamping Sleeve

29 Conical Enlargement

30 Conical Enlargement

31 Clamping Sleeve

32 Rubber Bearing

1-10. (canceled)

11. A bearing device (7; 8), for a leaf spring assembly (1) of a wheel suspension, comprising:
a leaf spring (2),
a connection assembly (9) serving to connect the leaf spring (2) to a vehicle body,
the connection assembly (9) having a bolt (10),
the leaf spring (2) being fabricated from a fiber composite material and being penetrated transversely by a recess (11) through which the bolt (10) passes.

12. The bearing device (7; 8) according to claim 11, wherein the bolt (10) accommodates clamping devices (13, 14; 25, 26) located on both sides of the leaf spring (2), and the clamping devices (13, 14; 25, 26) are pre-loaded by the bolt (10) toward one another and thus against the leaf spring (2) which is positioned in between.

13. The bearing device (7; 8) according to claim 12, wherein each of the clamping devices (13, 14; 25, 26) comprises a clamping sleeve (15, 16, 27, 28, 31).

14. The bearing device (7; 8) according to claim 13, wherein the clamping sleeves (27, 28) are each equipped, at the sides of the leaf spring (2), with at least one of a conical and a cylindrical enlargement (29, 30) through which the respective clamping sleeve (27, 28) is pre-loaded against the leaf spring (2).

15. The bearing device (7; 8) according to claim 13, wherein a contact element (17; 18) is provided, between the leaf spring (2) and the respective clamping sleeve (15; 16) of the respective clamping device (13; 14), each of which is loaded through the respective clamping sleeve (15; 16) against the leaf spring (2).

16. The bearing device (7; 8) according to claim 15, wherein the contact elements (17; 18) has clamp-like projections (21; 22), through which the contact elements encompass the leave spring (2) from sides of the respective clamping device (13; 14).

17. The bearing device (7; 8) according to claim 11, wherein the connection assembly (9) comprises rubber bearings (32) through which an installation at the vehicle body is accomplished.

18. The bearing device (7; 8) according to claim 13, wherein rubber bearings (32) are placed on the respective clamping sleeves (31).

19. The bearing device (7; 8) according to claim 12, wherein the pre-load of the clamping devices (13, 14; 25, 26) is achieved by a screw fastening.

20. A leaf spring assembly (1) for a wheel suspension of a vehicle, comprising:
a leaf spring (2) being connected with part of a vehicle body by a bearing device (7, 8) having a connection assemblies (9) serving to connect the leaf spring (2) to the vehicle body,
the connection assemblies (9) each having a bolt (10),
the leaf spring (2) being fabricated from a fiber composite material and being penetrated transversely by recesses (11) through which the bolts (10) pass.

21. A leaf spring assembly of a wheel suspension comprising:
a leaf spring,
first and second bearing devices,
each of the first and the second bearing devices having a connection assembly which connects the leaf spring to a vehicle body,
each of the connection assemblies having a respective bolt,
the leaf spring being fabricated from a fiber composite material and has first and second transverse recesses extending through the leaf spring, and
the respective bolt of the first bearing device passing through the first recess and the respective bolt of the second bearing device passing through the second recess.

22. The leaf spring assembly according to claim 21, wherein each of the first and the second bearing devices comprises clamping devices which are supported by the respective bolts on opposite transverse sides of the leaf spring, and the clamping devices on the respective bolts being pre-loaded against each other thereby clamping the leaf spring therebetween.
